(19) United States
(12) Patent Application Publication
(10) Pub. No.: US 2018/0032612 A1
(43) Pub. Date: Feb. 1, 2018

(54) AUDIO-AIDED DATA COLLECTION AND RETRIEVAL

(71) Applicant: Alexander Kariman, Rockville, MD (US)

(72) Inventor: Alexander Kariman, Rockville, MD (US)

(73) Assignee: Secrom LLC, Reston, VA (US)

(21) Appl. No.: 15/701,449

(22) Filed: Sep. 12, 2017

(51) Int. Cl. G06F 17/30

(52) U.S. Cl. CPC G06F 17/30764; G06F 17/30743; G06F 17/30026; G06F 17/30604; G06F 17/3012

(57) ABSTRACT

The disclosed invention includes methods and systems for performing audio-aided data collection and retrieval, where the data collection and retrieval is related to one or more persons, or subjects or objects associated with one or more persons. The data collection and retrieval is performed with a help of audio data that contains at least some human audio biometrics or non-human audio characteristics and some annotation data of said audio data. The data collection and retrieval involves: audio data and annotation collection, audio data analysis and searching for similar audio data or its product, data searching and processing, results aggregation and presentation, and optional collection of feedback.

### FIELD OF THE INVENTION

This invention relates to an information collection and retrieval system, which enables collection and retrieval of data using audio signals and annotation data. The data retrieved involves information about people and subjects and objects directly or indirectly associated with people.

### BACKGROUND OF THE INVENTION

The described invention proposes new systems and methods for improving productivity of employees, decision support, and security risk management, addressing several key issues that organizations and people face today.

Effective internal information sharing in large companies is often a problem, leading to development of knowledge silos that demote cooperation, create duplicate efforts, reduce productivity, and increase costs. Business development, sales, and procurement personnel meet new people daily, but the knowledge about these meetings is rarely shared across the organization, beyond the generic business productivity tools.

Timely knowledge about encounters and people, the context, the outcomes, and possible complications—all, are essential for productivity and security management. Today, many face-to-face meetings take place in the cyberspace. Employees often have little time and ability to make inquires or conduct due diligence on people they meet. Employees need information that is meaningful and actionable, delivered in real-time to provide decision support and increase productivity.

Security risk management is another important field. International organizations with travelling personnel, companies working in high risk environments or having significant exposure to fraud, walk-in businesses, and others—are all subject to physical security risks, and need a cost-effective solution to address the security challenges. Ability to obtain instant background information, actionable intelligence, relevant analytic judgments, proactively notifying authorities, or simply receiving alert if a threat is detected, is important for safety and security of businesses and personnel.

A number of voice-based database query and fraud prevention systems are known. However, they are not intended to provide real-time individual's background information for decision support and risk management purposes. The proposed invention presents a number of innovations in the technical field as well as technology application. In some embodiments, the proposed invention provides not only a convenient mechanism for near-real-time retrieval of actionable information, but it also provides a mechanism for collecting, using, and refining new, highly targeted information, in addition to improving the current knowledge, ideally, with every retrieval transaction.

In one disclosure, for example, as described in the U.S. Pat. No. 7,810,020 B2 (Publication date Oct. 5, 2010), there is an information retrieval system comprising of an apparatus that extracts episodic information on each participant of an audio/video conference from a sound and image that are captured during the conference. The system further comprises of an information storage portion that stores the extracted episodic information associated with personal information related to each participant. And the system also includes an information retrieval portion that retrieves the said personal information based on any of the extracted episodic information that includes: number of conversation times, number of remark times, total conference conversation period, etc.

In another disclosure, for example, as described in the U.S. patent application Ser. No. 12/856,200 (Publication date Mar. 1, 2012), there is a method for screening an audio recording for fraud detection. The method comprising of a user interface capable of receiving an audio recording and comparing the recording with a list of fraud audio recordings, assigning a risk score to the audio recording based on the comparison with some potentially matching fraud audio recordings, and displaying the score on a display screen, and playing the audio recording along with the potentially matching fraud audio recording. In addition, the display screen further displays metadata for each of the audio recordings and the potentially matching fraud audio recordings, wherein the metadata includes location and incident data of each of the audio recordings.

In another disclosure, for example, as described in the U.S. Pat. No. 7,940,897 B2 (Publication date May 10, 2011), there is a word recognition system and method for customer and employee assessment that involves one-to-many comparisons of callers' words and/or voice prints with known words and/or voice prints to identify any substantial matches between them. The identification of any matches may be used for a variety of purposes, such as providing feedback to a service representative or customer follow-up.

In another disclosure, for example, as described in the U.S. Pat. No. 7,272,565 B2 (Publication date Sep. 18, 2007), there are a system and a method for monitoring individuals by matching monitored speech with stored voice prints. Voice prints of individuals are obtained and stored in a central repository for use by an entity that monitors voice communications. The digitized voice prints are used to identify speakers and if the monitor suspects a speaker of illegal activity, the monitor may seek additional information about such speaker by accessing information associated with voice prints and retrieving said information for further action.

In another disclosure, for example, as described in the U.S. patent application Ser. No. 10/975,859 (Publication date Jun. 9, 2005), there is a method of detecting a likelihood of voice identity fraud in a voice access system, comprising the steps of storing a database of voice characteristics for users, determining a corresponding series of voice characteristics for the new user's voice, reviewing the database of voice characteristics to determine voices having similar voice characteristics, and reporting about the users that have similar voice characteristics.

In another disclosure, for example, as described in the U.S. patent application Ser. No. 13/415,809 (Publication date Oct. 4, 2012), there are systems, methods, and media for determining fraud risk using audio signals and non-audio data that include: receiving an audio signal and an associated audio signal identifier, receiving a fraud event identifier associated with a fraud event, determining a speaker model based on the received audio signal, determining a channel model based on a path of the received audio signal, updating a fraudster channel database to include the determined channel model based on a comparison of the audio signal identifier and the fraud event identified, and updating a fraudster voice database to include the determined speaker model based on a comparison of the audio signal identifier and the fraud event identifier.

### SUMMARY OF THE INVENTION

The following methods and systems present a simplified view of one or more aspects of the proposed invention. This summary is not an extensive overview of all contemplated embodiments and implementations. It is intended to neither identify key or critical elements of all features, nor delineate the scope of any or all facets. Its sole purpose is to present some concepts of one or more aspects in a simplified form.

According to the present teachings in one or more aspects, the methods and systems provided herein are for performing audio-aided data collection and retrieval, where the data collection and retrieval is related to one or more persons, or subjects or objects associated with one or more persons. The data collection and retrieval is performed with the help of audio signals that contain human audio biometric data, and/or non-human object audio characteristics data, and may contain some annotation information related to the audio signals or the signals source(s).

A data retrieval query starts with a capable electronic device acquiring audio data, using, for instance, a microphone, and obtaining at least some annotation data associated directly or indirectly with the audio data or one or more audio data sources. A device user can provide the said annotation using a user interface, and/or the device can provide the said annotation by automatically capturing any relevant information available to the device (e.g., location information, time, device name, user name, information pre-configured by the user or the device manufacturer, available information selected as a result of audio data pre-processing, etc.). The device can then pre-process, if necessary, any audio and annotation data, and/or transmit this information without the pre-processing over a network, such as the Internet, to one or more server-systems for processing.

The server-system receives said information (audio-aided query) and processes it. Once the information is processed, the server-system transmits a report back to the device, where the report includes at least some information related to one or more persons and/or subjects or objects related to a person, for instance: a motor vehicle make/model that belongs to a person whose voice was captured in the audio session; or to the contrary, an audio record of a motor vehicle sound yields information about the owner, such as the owner's name, address, picture, etc. The user can then review the report and provide, if necessary, some feedback with additional details, if known to the user, which enhances the knowledge about the person, and/or related subjects or objects (such as a motor vehicle), as well as increases the accuracy and completeness of future reports.

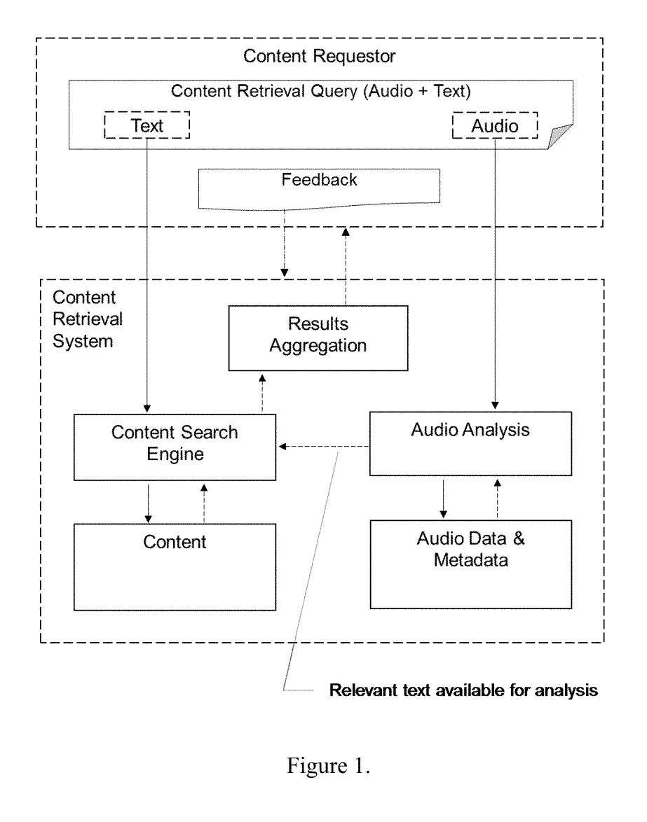

A conceptual outline of one of the many possible embodiments of the proposed invention is presented in the FIG. 1. A content requestor generates an audio-aided query that consists of an audio signal and some annotation text relevant to a subject and/or object emitting the signal. The content requestor sends this information to a content retrieval system that includes a logical content search engine (search system) and a logical sound recognition system (audio analysis system), each being coupled with a corresponding logical data storage (collection of resources), and a logical results aggregation system. The sound recognition system processes the audio data or its product and finds similar audio data or its product, as well as any associated data. The sound recognition system provides to the search engine any discovered relevant data for analysis, and makes available to the results aggregation system any said data for inclusion, if necessary, in the report. The search engine searches for relevant content based on the annotation data and the relevant data discovered/generated by the sound recognition system, and provides the results to the results aggregation system. The results aggregation system compiles a report as required, and sends it to the content requestor. The content requestor receives the report and optionally provides some feedback to the content retrieval system with additional details known to the requestor.

In one embodiment of the proposed invention, a premises audio/video surveillance system that automatically and continuously records and transmits audio and video data streams, captures a video frame containing a visitor (person) and an audio snippet of speech containing the visitor's voice. The audio/video surveillance system automatically provides camera/microphone location data (explicitly or implicitly, e.g., providing the camera/microphone network or physical address, etc.), time-stamp, and other available annotation data, as well as the image of visitor (or a video) as part of the annotation. The surveillance system submits the audio-aided query in one or more transactions (or continuously streams the audio data and/or other annotations) to the server-system for processing; and in another implementation, the surveillance system periodically sends one or more audio snippets and annotations to the server-system for processing.

The server-system identifies, based on the audio data and the annotations, that the visitor is a human, who is likely to be a male, and speaking a foreign language. In addition, the audio data is used to attempt to analyze the intent of the person by extracting and analyzing the speech content.

Furthermore, the server-system extracts a voice model and checks it against a known-person database to determine the person's identity, and then stores the voice model and additional data for future references.

In addition, the server-system concludes that the person is distressed based on the voice characteristics; and in another embodiment, corroborating this conclusion with face emotions and behavioral recognition technologies, using the visual data provided as part of the annotations. In another embodiment, this information is processed together with video data, such as facial recognition technology, to obtain additional insights.

Next, the server-system produces a risk profile, calculating the person's security risk factor based on the aforesaid “situational” information, available historic/statistical information relevant to the case, person's criminal record, if the person was identified, and the real-time information supplied by a local news media, and/or the law enforcement, and/or social media, to determine criminal activity and current alerts in the area, etc. The server-system then calculates a final risk factor and determines the appropriate action; where in one implementation, such action includes proactively locking the entrance door, sending alerts (e.g., SMS, automated phone call, etc.) to the nearest security personnel, and sending a detailed report to one or more designated persons (e.g., an officer on duty, etc.).

In another embodiment of the proposed invention, an employee, speaking on a telephone, captures a voice of another participant, using either a mobile app, a corporate Private Branch Exchange (PBX) system, a phone feature, or sending a command to the communication service provider. The employee then provides some annotation of the captured voice record, such as the person's last name or telephone number and sends the audio-aided query to the server-system for processing. In addition, or alternatively, the mobile application, the PBX system, the phone, or the telecommunication service provider automatically provides annotation, such as the participant's caller ID number, call time, location information, etc., and sends the audio-aided query in one or more transactions to the server-system for processing.

The server-system identifies the said person using voice recognition technology, searches multiple databases, and finds relevant information about the person (e.g., last name, date of birth, previous encounters by other employees, criminal and other governmental records, social network accounts, associated people and business entities, etc.). The server-system then sends this information back to the employee, for instance, to a mobile app, initiating the transmission by using a push message. If the employee then decides to upload the report, the app uploads the report and displays it to the employee. The employee meanwhile remains on the telephone with said person. The employee can review the report and provide additional information, if known, by sending some feedback to the server-system.

The feedback interface, in this implementation, also includes an optional questionnaire, if the server-system determines some critical information gaps regarding said individual, that the employee (user) may be able to fulfil. The questionnaire, in one implementation, is automatically compiled as part of the audio-aided query processing, if the server-system identifies critical information gaps and believes that the user may have the knowledge and ability to fulfill them. The server-system also assembles a wiki-type profile page for each encountered individual, as part of one or more wiki-type profile repositories, consisting of information compiled as a result of processing the audio-aided queries, other relevant information provided by users, and information amassed from other resources (not part of the query processing).

In another embodiment of the proposed invention, a private investigator captures a conversation of multiple individuals using a special microphone connected to a transmitter device, transmitting the information to a remote network-enabled mobile computer. The investigator captures the audio recording (or configures real-time audio streaming), and using software provides some annotation data related to the conversation and/or its participants. The application then sends the audio-aided query to the server-system, but before the transmission, it determines that the network bandwidth is low and pre-processes the audio data for more efficient transmission.

The server-system receives and processes the pre-processed audio data and annotations to find possible matches and associations with people, objects, and prior query requests. The server-system analyzes the data with the help of a specialized third-party service to determine the language, the number of people in the conversation, their gender and age group, as well as it analysis the ambient noise that could be characteristic of a type of location or a specific known location, if the sound matches a record of known location. The server-system also conducts voice analysis of each individual and searches available data for a possible match, as well as analyzes the conversation for monitored key words or phrases. The server-system then compiles a report and sends it to the investigator.

In another embodiment of the proposed invention, a customer service desk of a bank receives a phone call from an individual asking to obtain access to a bank account. If the service desk clerk suspects that the request is fraudulent, he/she can trigger an audio-aided query by sending a tone signal (DTMF) to the bank's PBX. The PBX locates the audio file of the ongoing call, where in one implementation, the audio file may also include annotations, such as the caller's name and other responses obtained by the Interactive Voice Responder (IVR) in the beginning of the call. In addition, the PBX may also locate the call details (Call Detail Records) and includes them in the query as part of the audio data annotation.

Alternatively, the PBX may record the IVR responses separately and include them as text (speech-to-text), annotating the audio data. And in another implementation, the service desk operator may provide annotations using call center software. The PBX system then sends the audio-aided query to the server-system for processing. The server-system receives and processes the audio data and annotations to generate a voice model and search available records to locate any previous encounters with the caller, obtain the caller's background report, and automatically assess if the caller is a fraud risk. The server-system then sends a response, for instance, “yes”, “no”, or “no record”, to the service desk clerk, and optionally, upon the clerk's request, sends a detailed background report, containing records of past encounters across all branches and offices of the bank, available biographic, criminal, and other information for further assessment.

In another embodiment of the proposed invention, a victim (user) of anonymous harassment by phone (or in person) initiates an audio-aided query using a phone app or sending a DTMF signal to the telephone service provider. The app or service provider records the harassment call and activates an audio-aided query. The victim may provide some annotations, using the app interface or, in case of a service provider, by voice-responding (or DTMF-responding) to the IVR questions, as part of the audio-aided query initiation. The app then sends the request to the server-system for processing, or the service provider initiates the query processing. Once the query is processed, the user receives a report containing details of possibly matched individuals. In one embodiment, such report can be an audio report transmitted by phone, or a document, or an interactive web-page, etc. And in another embodiment, the user can request additional information by answering questions proposed by the server-system as part of the interactive report, where the user's responses are sent back to the server-system as feedback.

### BRIEF DESCRIPTION OF THE DRAWINGS

The accompanying drawings, which are incorporated in and constitute a part of this specification, illustrate aspects of the present teachings and together with the description, serve to explain principles of the present teachings.

The FIG. 1, provides a conceptual outline of one of many possible embodiments of the proposed invention, where a content requestor generates and sends an audio-aided query to a content retrieval system that includes a search engine and an audio analysis system, each being coupled with a corresponding logical data storage, and a logical results aggregation system. The audio analysis system processes the audio signals, for instance, by extracting certain features and comparing them with other audio data and providing to the search engine any discovered data that is associated with the relevant audio data (e.g., a speaker's name, etc.) for searching. The audio analysis system also makes available to the results aggregation system any relevant data, including text, images, and audio data, for inclusion, if necessary, in the report. The search engine searches for relevant content based on the annotation data and the relevant data discovered/generated by the audio analysis system, and provides the results to the results aggregation system. The results aggregation system compiles a report and sends it to the content requestor. The content requestor receives the report and optionally provides feedback with additional known details back to the audio-aided data collection and retrieval system.

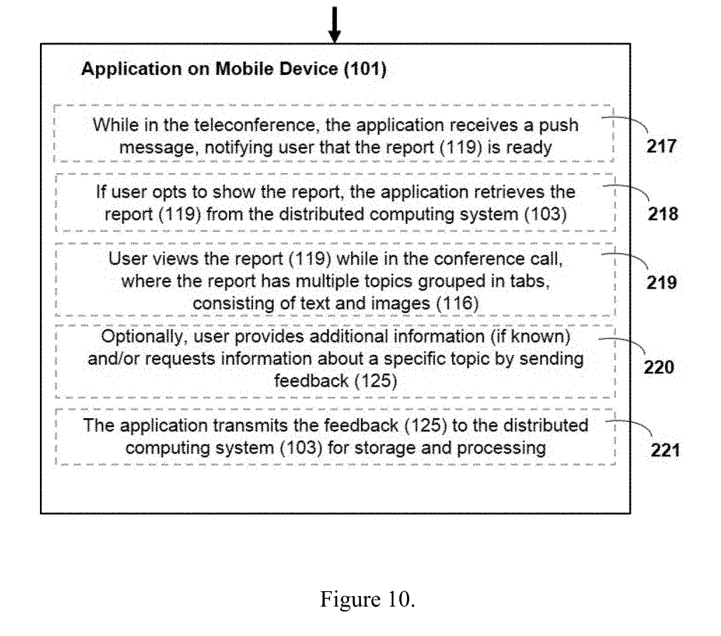

The FIG. 2A, provides a schematic view of the interaction between a user and a server-system, where the user initiates an audio-aided data retrieval query, sending to the server-system a request, consisting of audio signals and some annotation, and receiving from the server-system a report, and then sending feedback to the server-system.

The FIG. 2B, provides a schematic view of the interaction between a user and a server-system, where the user accesses the server-system via a user interface to view reports and wiki-type profiles.

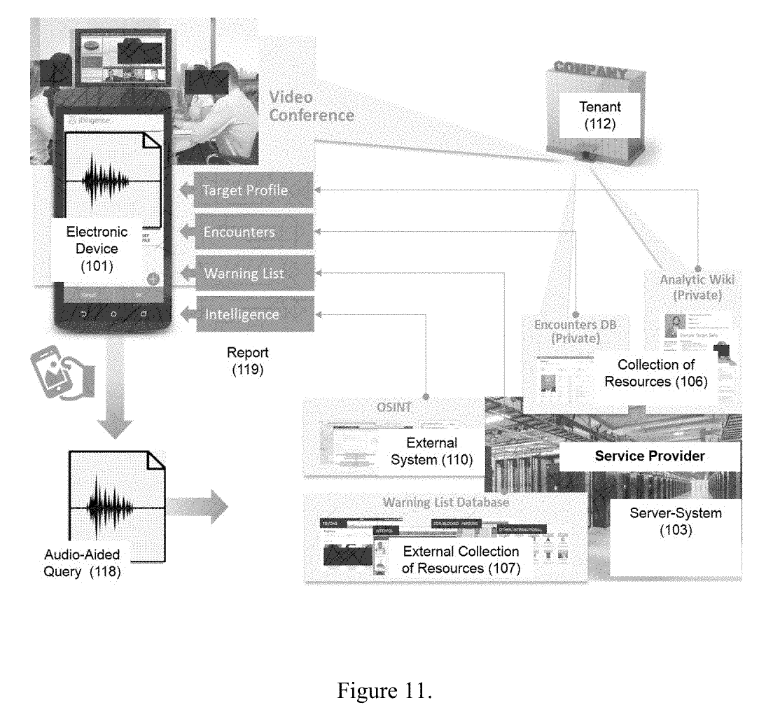

The FIG. 3, provides a basic view of the server-system and its main subsystems that include: one or more audio analysis systems, one or more search systems, one or more collections of resources, as well as external systems and multiple interfaces.

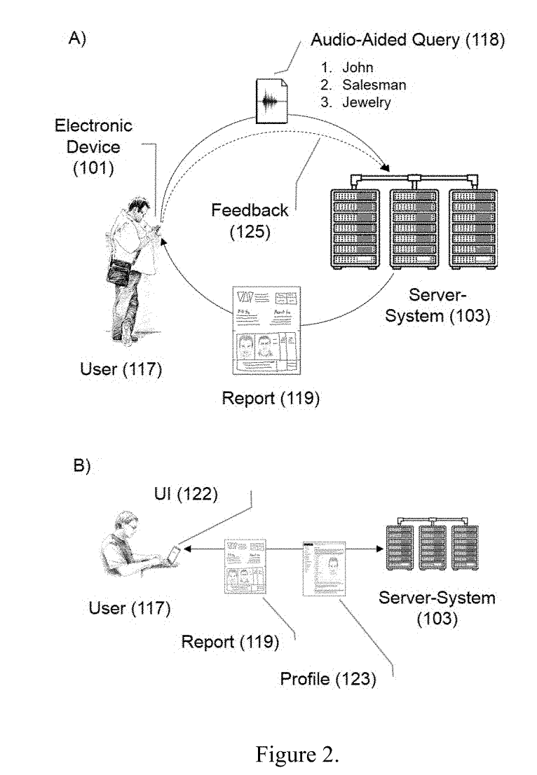

The FIG. 4, provides an example of some, among many possible, sources of audio signals that are processed by the audio-aided data collection and retrieval system, and some, among many possible, electronic devices that are capable of providing audio data or its product for an audio-aided query.

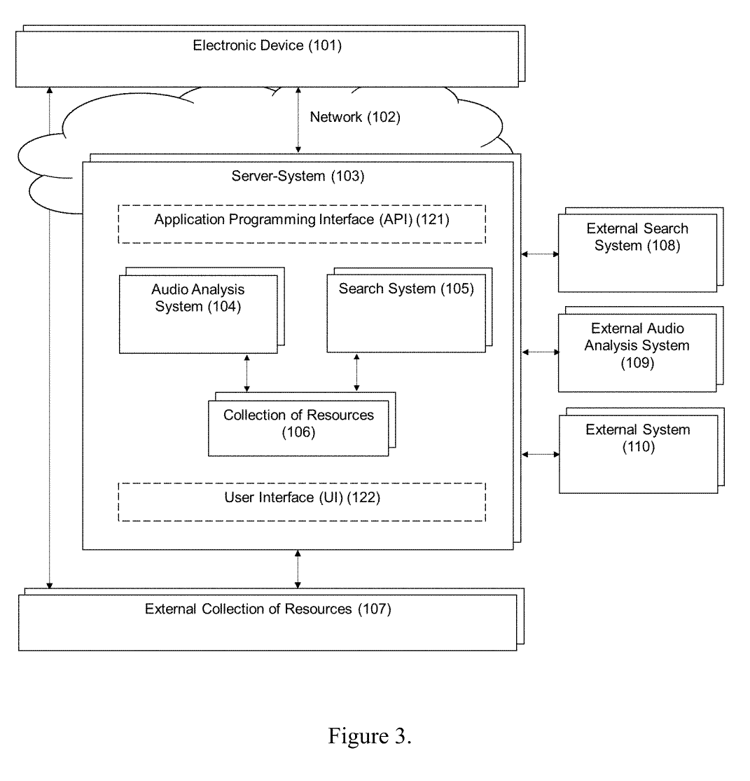

The FIG. 5, depicts an embodiment, where an audio-aided query is processed concurrently, sending the audio-aided query to one or more audio analysis systems, and one or more search systems, and one or more external systems.

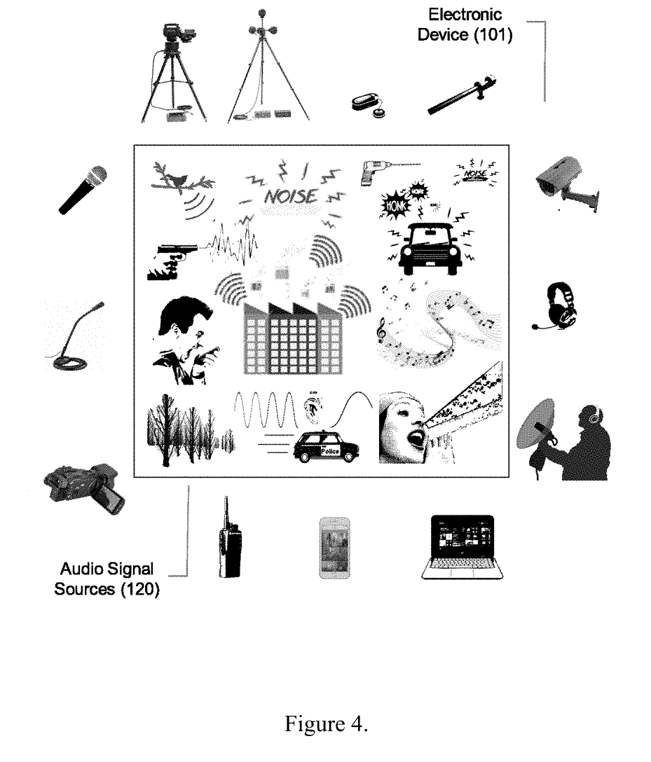

The FIG. 6, depicts an embodiment that is similar to the FIG. 5, but where some steps of the audio-aided query processing are executed consequently and others concurrently.

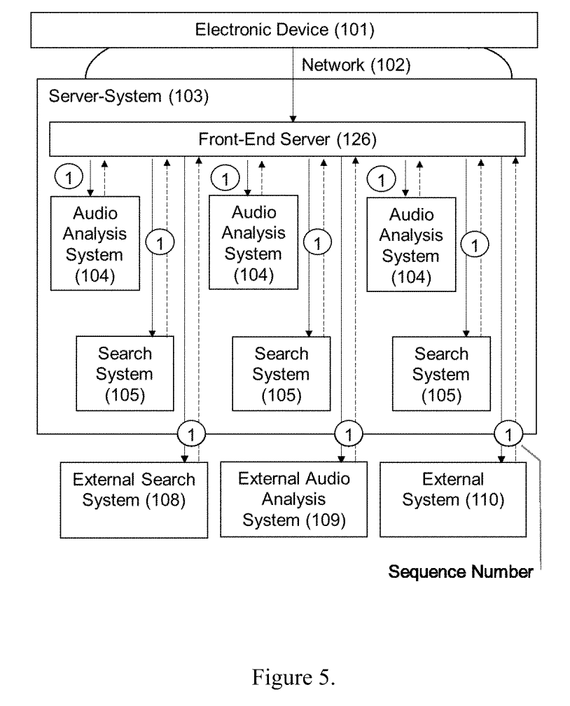

The FIG. 7, depicts some of the mobile application-implemented query and report interfaces.

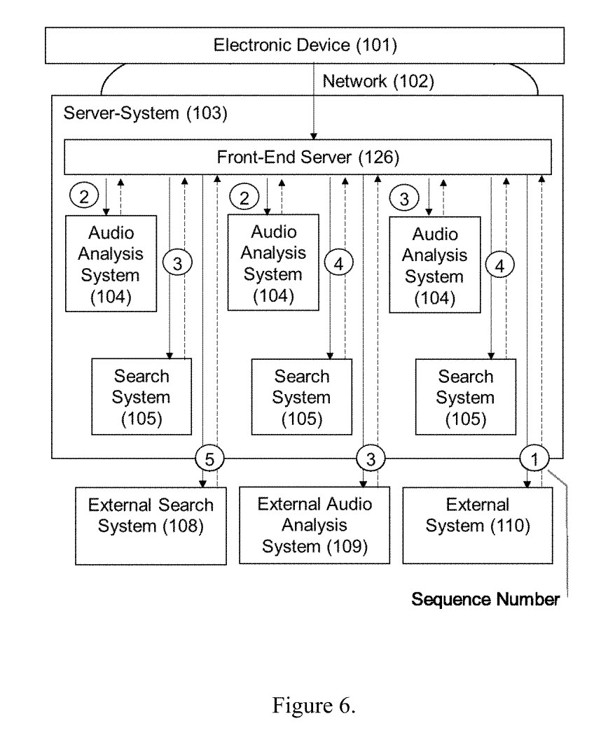

The FIG. 8, provides a general overview of one embodiment, where the audio-aided data collection and retrieval system and method are integrated into a teleconferencing system, and the illustration depicts some events of initiating an audio-aided query in a mobile teleconferencing application.

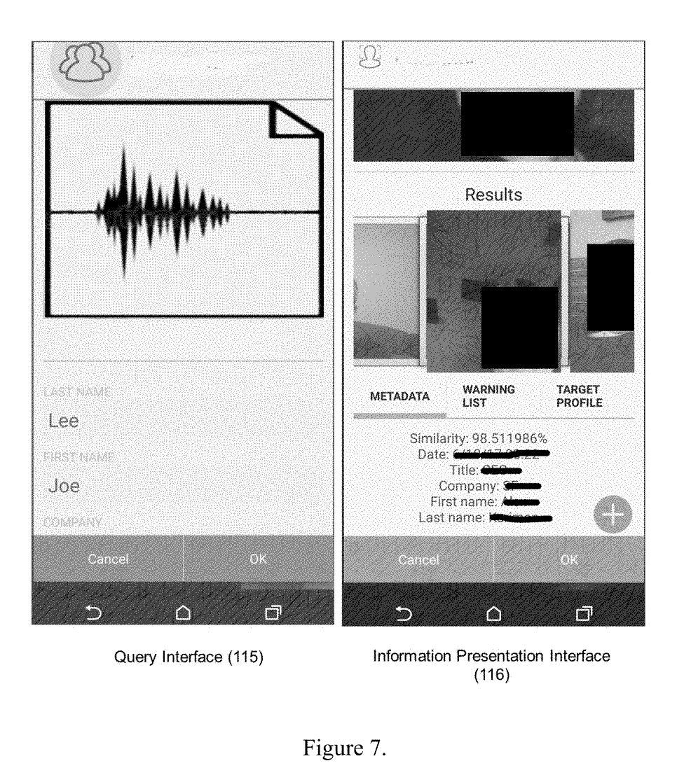

The FIG. 9, provides a general overview of one embodiment, where the audio-aided data collection and retrieval system and method are integrated into a teleconferencing system, and the illustration depicts some events of processing an audio-aided query on the server-system.

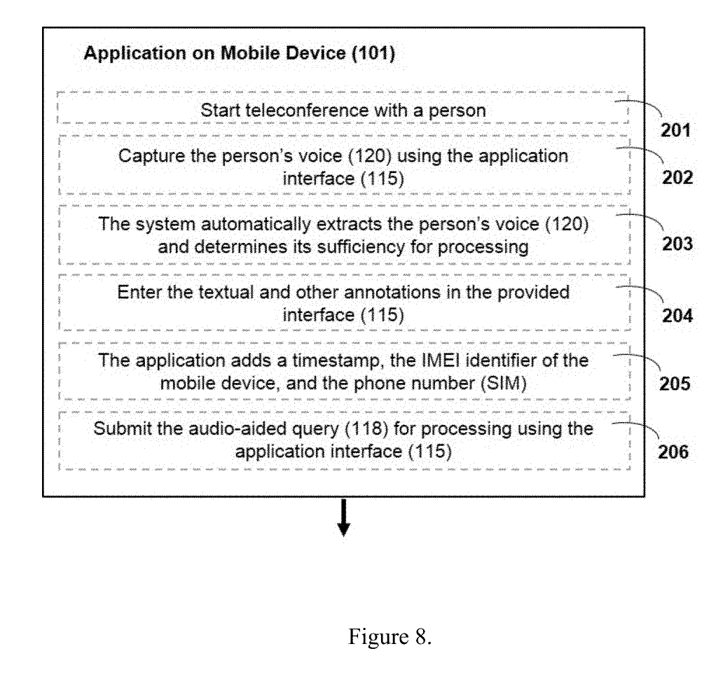

The FIG. 10, provides a general overview of one embodiment, where the audio-aided data collection and retrieval system and method are integrated into a teleconferencing system, and the illustration depicts some events of a mobile teleconferencing application receiving an audio-aided query report and performing some subsequent steps.

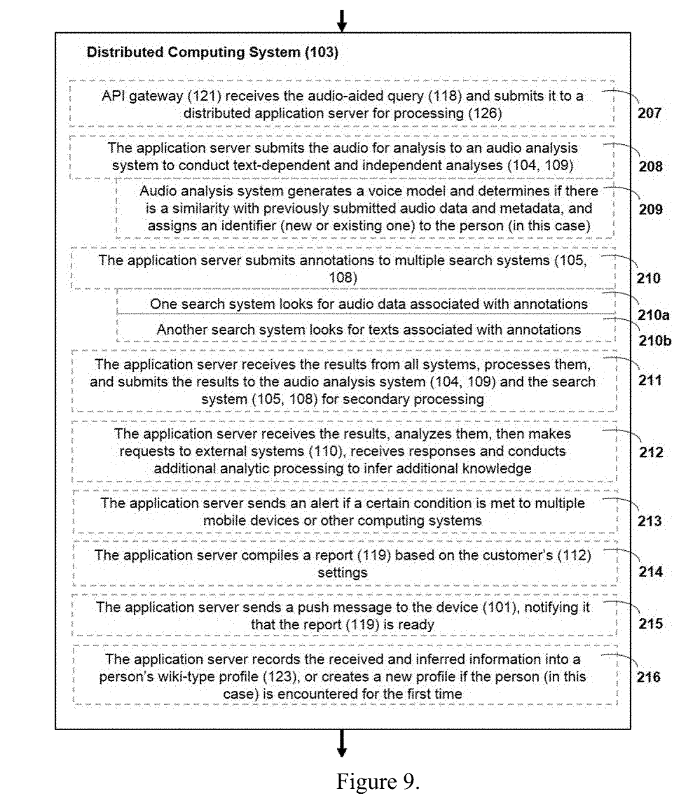

The FIG. 11, provides a general overview of one embodiment, where the audio-aided data collection and retrieval system and method are integrated into a teleconferencing system (solution), and the illustration depicts a customer receiving the said solution as a service, having some private resources, namely: the Encounters DB (database), the Analytic Wiki (wiki-type profile repository), and the Video Conference system; and having some shared resources (all others) that are provided by the service provider as part of the solution.

### DESCRIPTION OF EMBODIMENTS

Reference will now be made to embodiments, examples of which are illustrated in the accompanying drawings. In the following description, some details are set forth in order to provide understanding of the proposed invention. However, it will be apparent to one of ordinary skill in the art that the present invention may be practiced without these details. In other instances, well-known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. Moreover, the term “or” is intended to mean an inclusive “or” rather than an exclusive “or.” That is, unless specified otherwise, or clear from the context, the phrase “X employs A or B” is intended to mean any of the natural inclusive permutations. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if is detected” may be construed to mean “upon determining” or “in response to determining” or “upon detecting (the stated condition or event)” or “in response to detecting (the stated condition or event),” depending on the context.

As used herein, the terms “produced data”, “data produced” “located data” or similar, depending on the context, also includes data about absence of data or a result. For instance, a database query that produced no results relevant to the query had produced data about absence of the results (data in the database). In another instance, a voice analysis system that did not produce results of voice analysis (data), had produced results (data) about the absence of results (data) for whatever reason, such as inability to process a voice recording, an error, no data produced as a result of voice model comparison, etc.

As used herein, the terms “data related”, “related data” or “related information”, “information related”, or “related”, or “in connection”, or “associated”, or “relevant”, and similar, depending on the context, means any association, whether direct or indirect, by any applicable criteria as the case may be.

The word “exemplary” is used herein to mean “serving as an example, instance, or illustration”. And no aspect of this disclosure shall be construed as preferred or advantageous over other aspects or designs unless expressly stated.

Each of the operations described herein may correspond to instructions stored in a computer memory or computer readable storage medium. Each of the methods described herein may be governed by instructions that are stored in a non-transitory computer readable storage medium and that are executed by one or more processors of one or more servers or clients.

The term “push” or “push message” or “push technology” may also mean a server initiating data transfer rather than a client, or a push messaging service. The term “pull” or “pull technology” may also include network communications where the initial request for data originates from a client, and then it is responded to by a server. The term “operating system” may be understood as an independent program of instructions and shall furthermore include software that operates in the operating system or coupled with an independent program of instructions.

A “circuit” or “circuitry” may be understood as any kind of logic-implementing entity, which may be hardware (including silicon), software, firmware, net-ware, or any combination thereof. Thus, a “circuit” or “circuitry” may be a hard-wired logic circuit or a programmable logic circuit such as a programmable processor, e.g. a microprocessor, a computer, a network of computers, a distributed computing system (or infrastructure), and the like. A “circuit” or “circuitry” may also be software being implemented or executed by a processor, e.g., any kind of computer program. It may also be understood to be a computing service (e.g., Infrastructure or Software-as-a-Service, etc.) Any other kind of implementation of the respective functions described herein may also be understood as a “circuit” or “circuitry”.

A “processor” may also be understood as any number of processor cores or threads, controller, or microcontroller, or plurality and combination thereof. The terms “coupling” or “connection” or “linking” are intended to include a direct coupling or a direct connection, as well as an indirect “coupling” or an indirect “connection” respectively, as well as logical or physical coupling and communicative or operational coupling, which means coupling two or more discrete systems or modules, or coupling two or more components of the same module respectively. A “coupled or connected device” or similar, may be understood as a physical, a logical, or a virtual device.

A “network” may be understood as any physical and logical network, including the Internet, local network, wireless or wired network, or a system bus, or any other network, or any physical communication media, or any combination of any networks of any type. A “message” or a “notification” may be used interchangeably and may be understood to mean “data”.

A “memory” may be understood to be any recording media used to retain data that includes, without limitation: high-speed random-access memory, such as DRAM, SRAM, DDR RAM or other random-access memory, non-volatile memory, such as one or more magnetic disk storage devices, optical disk storage devices, flash memory devices, or other non-volatile storage devices. It may also be understood to include one or more storage devices remotely located from the processor(s); and the non-volatile memory device(s) within memory, comprising of a non-transitory computer readable storage medium, or any other electronic data storage medium.

An “audio data”, or “audio information”, “audio signals” “audio stream” or similar may be understood to include all types of audio signals that have been encoded in digital form.

An “electronic device”, or “device”, or “client device” may be understood to be any circuitry, including one or more applications, such as a browser plug-in application, a search engine extension, an “omnivorous” user interface box, which allows users to upload audio data and provide annotations, any server or client endpoint, or any electronic circuit, such as, without limitations: a video surveillance system, a teleconferencing system, a distributed computing system, a desktop, a tablet or notebook computer, a mainframe computer, a server computer, a mobile device, a mobile phone, a personal digital assistant, a network terminal, a set-top box; or a specialized device, such as, without limitations: a long-range microphone, a biometric scanner, an electronic sound detection system, a target acquisition system, an electronic audio/video camera, a sonar, a laser; or any other device capable of producing data that can be processed by an audio analysis system.

A “server-system” may be understood to be any network-enabled electronic circuit, such as, without limitations: a distributed computing system, a server computer, a desktop, a tablet or a notebook computer, a mainframe computer, a mobile device, a cloud computing service, a server-less computing service that can execute programs, or any combination thereof; and to any extent of automation, including a significant part of the tasks described herein, requiring and performed using manual human labor.

An “audio analysis system” may be understood to be any circuitry that can conduct at least some audio analysis.

A “search system” may be understood to be any circuitry, including a distributed computing system, that can enable searching of at least some data in one or more collections of resources, and that can deliver at least some information associated with a query. Such information can comprise of visual, auditory, or sensory content, or a descriptor of a location to make such content accessible. For example, without limitations, the information content can be in the form of: an image, an audio file, a voice model file, a text, a Universal Resource Locator (URL), a Wireless Application Protocol (WAP) page, a Hyper Text Markup Language (HTML) page, an Extensible Markup Language (XML) document, a Portable Document Format (PDF) document, a database query, an executable program, a filename, an Internet Protocol (IP) address, a telephone number, a pointer, identifying indicia, or any other data in any format. In addition, the searching can be of static data or streaming data, and transactional or continuous, or any other kind.

An “audio analysis” may be understood as extraction of information or meaning from audio signals for analysis, classification, storage, retrieval, synthesis, etc. Audio analysis may also be understood as application of one or more analysis techniques by the audio analysis system, including without limitations: text-dependent analysis, text-independent analysis, unsupervised audio analysis, analysis using an audio classification framework obtained from off-line aalysis and training, feature extraction, pattern recognition, various technologies used to process and store voice models, semantic audio analysis (e.g.: extraction of symbols or meaning from audio data, such as speech recognition, language recognition, speaker or gender identification, activity or object or place identification, etc.), searching audio data and/or audio data product, and/or audio-related data, and other audio analysis techniques, for example, without limitations: audio recognition (e.g., static learning algorithms, dynamic learning algorithms, ensemble learning, evaluation, etc.); audio source separation; audio enhancement methods (e.g., audio signal pre-processing methods, feature enhancement methods, model architectures, etc.); speech recognition (e.g., linguistics, non-linguistics, paralinguistics, etc.); music analysis; sound analysis (e.g., animal vocalizations, acoustic events, emotions, etc.); short time analysis; audio activity detection; audio feature extraction; activity recognition, source location or distance detection; source motion estimation; mood, emotion, or stress recognition of a human audio source; named entity audio recognition; landmark recognition; forensic and biometric audio signatures; and similar audio analysis techniques and systems.

An “external source” or “external system” or “external” may be understood to be any circuitry, or any service, or any information resource, or any logical or physical system or module, or any data that exists logically or physically outside of the embodiment described, depending on the context, or that is sourced from an unrelated entity or a third-party, or outsourced to a third-party. For instance, an external system can be, without limitations: a telecom company that provides SMS services used in one of the embodiments to send or receive SMS messages, or a push service provider, or, for instance, a motor vehicles records provider, such as Motor Vehicle Administration, etc.

A “collection of resources” may be understood to be a system, a platform, a circuitry, or a capability to retain and/or make available at least some data, whether the data is static or streaming, or some structured or unstructured data stored in one or more datastore, or any logical or physical recording media used to retain or stream at least some data, such as, without limitations: a memory, a hard drive, a database, a file system, a data stream, an archive, a library, a registry, a web-page, a knowledge-base, a metadata storage, a system log storage, etc., and any combination thereof.

An “analytic action” may be understood to be any data processing activity, or a process of, without limitations: discovery, transformation, interpretation, optimization, and communication of data; or activities that, without limitations: define, create, collect, verify, sort, or transform data into a more meaningful information, such as: reports, analyses, recommendations, optimizations, predictions, automations, and the like.

“Human audio biometric data” may be understood to be any audio signal related to physical human characteristics (e.g., voice, heartbeat, breath sounds, and the like).

A “person”, or “human”, or “individual” may be understood as a subject having a visually human appearance or attributes. The meaning also includes any elements, parts, and properties of the human body, as well as any common items, such as items of clothing, or as considered human-related by the audio analysis system, or the search system, or the analytic action, or circuitry.

“Non-human audio characteristics data” may be understood to be any audio signal not related to physical human characteristics.

A “profile” may be understood to be a collection of information about a certain object, subject or topic.

An “annotation”, or “annotation information”, or “annotation data” can be understood to be or include, without limitations: any identifying indicia or any pointer; user-generated text or other data; electronic device-generated data (e.g., any descriptive text, any parameters, binary data, metadata, etc.); an audio file, an audio file metadata, an audio stream, and audio stream metadata; device-accessible user data (e.g., pictures, documents, audio recordings, access credentials, settings, personal information, etc.); external data (e.g., data from sensors and other systems linked to the device); an audio, a video, or an image that is provided as annotation; any metadata; a data stream that is provided as annotation; a speech-to-text recording; and the like.

The present teaching relates to systems and methods for information collection and retrieval with the help of audio analysis and searching. More particularly, in one or more embodiments of the proposed invention, and as exemplified in the FIG. 2, the systems and methods are provided in which one or more electronic devices (101) initiate an audio-aided data retrieval query (118) upon a certain trigger (e.g., a user command or an event, etc.). The device then obtains audio signals and some annotation data, forms an audio-aided data retrieval query (118), and sends the query (118) to one or more server-systems (103) for processing. The device (101) may obtain the audio signals from a microphone or from a memory storage, or elsewhere; and the annotation data may be provided by the device user (117) via an interface (115), or it could be produced automatically by the device without the user's (117) involvement.

Furthermore, the audio signals may or may not contain useful data, but ideally, they shall contain at least some human audio biometric data and/or non-human audio characteristics data, and the annotation, ideally, should be relevant to said audio signals or their source. The server-system (103) then processes the query (118), and the electronic device (101) receives from the server-system (103) a response that includes a report (119) with at least some information in connection with one or more persons, and/or in connection with one or more subjects or objects that directly or indirectly relate to one or more persons.

In one embodiment, the said report (119) consists of an interactive document and/or a list of results; and in another embodiment, the report (119) is presented in one or more application interface windows (116). In some embodiments, the list of results is organized into categories (116). Each category contains one or more types of results; and in some embodiments, a category title or another item can be an interactive tab or another active element.

In embodiments where more than one category is returned in the report (119), such as multiple images (116) or recognized subjects or objects, the category displayed first has a higher category weight. In embodiments where the audio-aided query (118) includes human audio biometric data and/or non-human audio characteristics data of more than one object and/or person (multiple people), the server-system (103) may return a separate result for each identified person, subject or object. In some embodiments, the type of audio signals and/or annotation may dictate how the results are presented. And in another embodiment, the items included in the report (119) and/or presentation are configured by the user (117). In another embodiment, said report (119) may include, for example, without limitations: a binary response (e.g., yes/no, true/false, good/bad, etc.), and/or a scaled response (e.g., from a scale of 1 to 10), and/or information from previous queries (118), and/or include user follow-up actions, such as one or more follow up URLs, and the like.

In one embodiment, a user (117) may specify the type of report (119) or information to be presented, either at the time of placing the audio-aided query (118), or configuring the system in advance, or according to the tenant's (112) policy (as explained below). In this case, the server-system (103) will consider the user's (117) settings when processing the audio-aided query (118) and/or compiling a report (119). According to another embodiment, said report (119) may be displayed on the electronic device (101); and in another embodiment, the electronic device (101) may play the report (119) using an audio speaker, or present it in some other way.

In another embodiment, a user (117) can review the report (119) and provide, if necessary, some feedback (125) with additional details, if known to the user, by interacting with the report (119), where the user's (117) input is then transmitted to the server-system (103) and processed and/or recorded in one or more external (107) and/or internal collections of resources (106). The said feedback (125) system provides a mechanism for collecting new relevant data and increasing accuracy and completeness of the existing data.

In another embodiment, a user (117) may select and annotate one or more results in the report (119), where one or more annotations may serve as implicit feedback (125) that the results, or any part thereof, were relevant (or provide a degree of relevance or accuracy, etc.). Thus, said feedback (125) can also be used to improve the server-system (103) query (118) processing and reporting.

In another embodiment, a user's selection (e.g., a click on the “correct” button) from several of the same type of results, or choosing a more relevant image (116), provides feedback (125) to the server-system (103), improving the accuracy and completeness of the report (119), and providing additional information and/or enhancing the existing information. Said feedback (125) can include, for example, without limitations: a binary response (e.g., yes/no, true/false, good/bad, etc.), and/or a scaled response (e.g., from a scale of 1 to 10), etc.

In one embodiment, the server-system (103) can determine critical information gaps regarding an individual and/or related subject or object, and provide, for example, an interactive questionnaire as part of the report (119) for the user (117) to provide any known information. The response is then submitted to the server-system (103) as feedback (125). In another implementation, such questionnaire is generated by the server-system (103) and/or the device (101) according to configuration and logic and then provided as part of the report (119) or separate from the report (119).

The feedback (125) can be a clarification, a correction, additional information, a description, a review, and the like. For instance, such feedback (125) may provide person's most current telephone number or identify the most resembling image, etc. In one embodiment, said feedback (125) is sent to the server-system (103), and the front-end server (126) receives the feedback (125) and processes it as appropriate.

In one embodiment, the server-system (103) pushes a report (119) to one or more electronic devices (101) in one or more transactions or communication sessions. Alternatively, the electronic device (101) pulls a report (119) from one or more server-systems (103) (or one or more modules of one or more server-systems (103)) in one or more transactions or communication sessions. In another implementation, the electronic device (103) also obtains additional data from one or more external systems (110) and/or one or more external collections of resources (107), and/or obtains said report (119) from an intermediary system that stores such report (119). And in another embodiment, an electronic device (101) compiles at least some part of the report (119) after receiving some data from one or more server-systems (103) and other system(s).

According to the present teachings in one or more aspects, and as exemplified in the FIG. 3, the proposed system consists of a plurality of client electronic devices (101) that are communicatively coupled over a network (102) with one or more server-systems (103). In one embodiment, the electronic device (101) consists of a circuitry that has one or more processors and memory storing programs of instructions that can be executed by one or more processors. Said client electronic device (101) includes physical and logical network interfaces for wired and/or wireless communications, such as LAN, WAN, Wi-Fi, Bluetooth, GSM/CDMA, LTE, USB, CAN, etc.

In another embodiment, a client electronic device (101) has one or more operatively and/or communicatively coupled electronic monitors or displays, and a user interface accessible by the device user (117). In another embodiment, the said electronic device (101) has operatively and/or communicatively coupled one or more microphones capable of capturing audio signals, either continuously or upon a certain event. In another embodiment, an electronic device (101) can access a memory that is operatively and/or communicatively coupled with the device (101) to obtain audio data from said memory. In another embodiment, an electronic device (101) is also coupled with one or more video cameras and/or other sensors.

In another embodiment, an electronic device (101) is operatively and/or communicatively coupled with one or more sensors in a way that it can receive information from such sensors, for instance, without limitations: environmental sensors (temperature, pressure, humidity, etc.), human-wearable sensors (step-meter, heart rate meter, body temperature meter, O2 meter, glucose meter, and the like), Location-Based Services (LBS) sensors, gyro and proximity sensors, movement detection sensors, tripwire sensors, vibration sensors, heat sensors, and the like.

In another embodiment, a client electronic device (101) acquires and pre-processes an audio signal, either using a microphone or accessing a memory, and initiates an audio-aided query (118). Once the audio data is acquired, the device user (117) makes one or more inputs to designate one or more audio signals of interest. Alternatively, once the audio data is acquired, the said electronic device (101) detects one or more audio signal sources (120) based on the salient features or another technique. In another embodiment, the user (117) can make one or more inputs to indicate a selection of at least one audio signal source (120), and/or its type, whether detected by user (117) or prior detected by the device (101). In another embodiment, said device (101) can compare audio signals with locally or remotely stored audio data in order to identify the audio source or some other characteristics, and/or to categorize the audio source by type or other criterion.

In another implementation, said electronic device (101) can extract one or more audio models or some other data from the acquired audio data, based on the categorized or recognized audio signal sources (120) and/or some user (117) settings. In another embodiment, an electronic device (101) can automatically (without user's (117) involvement) generate some annotation data based on one or more recognized and/or categorized audio signal sources (120) as part of the audio-aided query (118) parameters acquisition.

In another embodiment, an electronic device (101) acquires and pre-processes an audio signal as part of the audio-aided query (118) parameters acquisition, where the audio data or any product thereof is pre-processed, either together with annotations or not, in a way that it is transformed (e.g., encrypted, compressed), or otherwise altered for whatever reason (e.g., to optimize transmission or processing, etc.). In another embodiment, an electronic device (101) acquires an audio signal and/or other parameters of an audio-aided query (118), and pre-processes them as described above but does not transmit the audio-aided query (118) to a server-system (103) until sometime later or upon a certain event, thus differing the query transaction as, for example, in the case of a network or system unavailability, power management reasons, batch transaction processing, or if configured by user (117), etc.

In one embodiment, the communications between one or more electronic devices (101) and one or more server-systems (103) are enabled via the following communication protocols, for example, without limitations: electronic mail (e-mail), short message service (SMS), multimedia messaging service (MMS), enhanced messaging service (EMS), WAP push, application push (e.g., push registry, etc.), a standard form of telephony, or standard internet protocols such as Transmission Control Protocol (TCP), IP, User Datagram Protocol (UDP), hypertext transfer protocol (HTTP), File Transfer Protocol (FTP), publish-subscribe protocols, or any other protocols.

According to one embodiment, and per the example in the FIG. 3, a server-system (103) consists of a circuitry, and in another embodiment, of a single computer, and yet in another embodiment, of a distributed computing system that includes one or more audio analysis systems (104), and operatively and/or communicatively coupled one or more search systems (105), and operatively and/or communicatively coupled one or more collections of resources (106).

In another embodiment, said audio analysis system can be an external audio analysis system (109), or a combination of one or more external (109) and one or more internal (104) audio analysis systems, configured to operate concurrently or consecutively. In another embodiment, said search system can be an external search system (108), or a combination of one or more external (108) and one or more internal (105) search systems, configured to operate concurrently or consecutively. And in another embodiment, said collection of resources can be an external collection of resources (107), or a combination of one or more external (107) and one or more internal (106) collections of resources, whether coupled or not (e.g., federated, mirrored, synchronized, etc.).

According to one embodiment, the server-system (103) is a multi-tenant system, serving multiple tenants (customers) (112), where the tenants' resources are segregated programmatically (e.g., application-level access control), and/or using virtualization technologies, and/or using network-level separation, and/or using hardware-level separation. The said multi-tenancy, in one implementation, is accomplished via a virtualization technology, where the resources of each tenant (112) are segregated into one or more virtual computing nodes; and in another implementation, the multi-tenancy is achieved using programmatic access control-based separation via a reference monitor or a similar technology; and in another implementation, the multi-tenancy is accomplished using network-based access control, such as private or hybrid networks (clouds), subnets, etc.; and yet in another implementation, the multi-tenancy is accomplished using separate physical computing nodes, or a combination of the aforesaid technologies.

In another embodiment, the server-system (103) represents a high-assurance distributed computing infrastructure that comprises of multiple redundant multi-regional operating environments that provide high service availability; and the said server-system (103) is constructed to comply with NIST 800-53 or similar current then recommendation regarding security and privacy controls of the Federal Information System, as well as to comply with Health Information Portability and Accountability Act (HIPAA) Security Rule, Technical Safeguards, and NIST 800-66 HIPAA Security Rule implementation or similar current then recommendation, and/or other relevant standards and guidelines pertaining to Federal Information Systems, healthcare and financial information systems, as well as specific requirements for handling sensitive or controlled information of various governmental agencies. Where in one embodiment, the systems, components, and methods of the proposed invention can provide multi-level and/or compartmented access control and operation (Multi-Level Security).

In another embodiment, the server-system (103) includes an application programming interface (API) (121) that facilitates communicative coupling of the server-system (103) and multiple external systems (110), and/or multiple external audio analysis systems (109), and/or multiple external search systems (108), and/or multiple electronic devices (101), and/or multiple external collections of resources (107). In another embodiment, the server-system (103) is implemented using the Service Oriented Architecture (SOA) design principles.

In another embodiment, the server-system (103) includes a user interface (UI) (122), where in one embodiment, the said UI allows one or more server-system administrators to administrate the server-system (103). And in another embodiment, the UI allows one or more administrators of one or more tenants (112) to administrate the tenant's resources and/or the tenant-applicable server-system settings. Said resources and settings may, without limitations, in one implementation, include a plurality of: audio records, images, annotations, data-sets, documents, software, circuitry, access control rules, notification rules, wiki-type profiles (123), integrations with tenant's private information systems and resources (e.g., Active Directory/LDAP integrations, private or hybrid clouds, telecommunication systems, private databases, private audio analysis and search systems, etc.). In another embodiment, said users (117) may belong (be grouped) to one or more tenants (112) and can access the server-system (103) using a user interface (122), where such users can, for instance: review the reports (119), review and/or edit audio records and/or metadata, review and/or edit wiki-type profiles (123), manage personal settings and perform other actions.

In one embodiment, the server-system (103) includes one or more front-end servers (126) or another circuitry and a system of load balancers, where the front-end server (126) or another circuitry is one or more web-servers that, in one implementation, reside in a private subnet, accessing the Internet through a system of proxy servers that reside in a demilitarized zone (DMZ) subnet. According to one implementation, the front-end server (126) or other circuitry provides an API interface (121), and receives one or more audio-aided queries (118) from one or more electronic devices (101). In another embodiment, one or more external (109) and/or internal audio analysis systems (104), and/or external (108) and/or internal search systems (105) receive one or more audio-aided queries (118) directly from one or more electronic devices (101), where in one implementation, said systems provide APIs (121) accessible over a network (102).

In another implementation, the front-end server (126) or other circuitry, upon receiving an audio-aided query (118), executes some processing logic, sending said audio data to one or more internal (104) and/or external audio analysis systems (109) for concurrent or consecutive processing, and/or storing said audio data in one or more external (107) and/or internal collections of resources (106), and/or sending said audio data to one or more external systems (110), and/or performing other actions. And in another implementation, the front-end server (126) or other circuitry, upon receiving an audio-aided query (118), executes some part of the processing logic, sending the annotation data to one or more internal (105) and/or external search systems (108) for concurrent or consecutive processing, and/or storing the annotation data in one or more external (107) and/or internal collections of resources (106), and/or sending said annotation data to one or more external systems (110), such as language translation or linguistic analysis system for multilingual or culture-aware processing.

And in another implementation, the front-end server (126) or another circuitry receives the results of processing of audio data and annotation data from an external (109) and/or internal audio analysis system (104), and/or external (108) and/or internal search system (105), and executes some analytic action, according to the analytic action configuration, generating additional results or transforming at least some data of the said received results, and then sending at least some data of the results to one or more internal (104) and/or external audio analysis systems (109), and/or to one or more internal (105) and/or external search systems (108) for concurrent or consecutive processing, and/or to one or more external systems (110), such as a language translation service or linguistic analysis system.

In another embodiment, said one or more front-end servers (126) or other circuitry receives one or more audio-aided queries (118) from one or more electronic devices (101). And the query audio data may include or consist of at least some pre-processing data generated on the electronic device (101), as described earlier. Accordingly, the front-end server (126) or another circuitry executes at least some audio-aided query (118) processing logic, sending said audio data to one or more internal (104) and/or external audio analysis systems (109) for concurrent or consecutive processing. If one or more front-end servers (126) or other circuitry receives said pre-processed audio data, for instance, containing information about the likelihood that a sub-portion of said audio data contains an audio signal of a certain source type, the front-end server (126) may pass this data to one or more audio analysis systems (104, 109) tailored for processing audio signal of a certain source type, and/or to one or more such search systems (105, 108), and/or to some other circuitry, and/or store this data in one or more collections of resources (107, 106).

In one embodiment, said one or more front-end servers (126) may receive at least some post-processing feedback (125) information, as described earlier, that user (117) provides in connection with the report (119). If one or more front-end servers (126) or other circuitry receives said feedback (125), it may pass this data to one or more audio analysis systems (104, 109), and/or to one or more search systems (105, 108), and/or to some other circuitry, and/or store this data in one or more collections of resources (107, 106).

In another implementation, the front-end server (126) or other circuitry may not pass said pre-processing and/or post-processing information as described above, but will instead use this information to augment the way it processes the results received from an audio analysis system (104, 109), and/or search system (105, 108), or another system as explained earlier.

In one embodiment, one or more external (109) and/or internal audio analysis systems (104) implement discrete or cooperative audio processing function, using one or more audio analysis techniques, including but not limited to text-dependent and text-independent analysis techniques, known to those skilled in the art. In one implementation, the external (109) and/or internal audio analysis system (104) consists of a program of instructions executed by one or more processors; in another—a circuitry; and in another—one or more computers; and yet in another—a distributed computing infrastructure; and in another—an external audio analysis service.

In one embodiment, one or more external (109) and/or internal audio analysis systems (104) are operatively and/or communicatively coupled with one or more external (107) and/or internal collections of resources (106). In one implementation, said audio analysis systems (104, 109) are operatively and/or communicatively coupled with a single external (107) and/or internal collection of resources (106). And in another implementation, said audio analysis systems (104, 109), each, is operatively and/or communicatively coupled with one or more individual external (107) and/or internal collections of resources (106), as well as in any combination and arrangement thereof as necessary to process an audio-aided query (118).

According to one implementation, a voice recognition system (104, 109) accesses a voice model collection of resources (106, 107) to look for a voice model that matches the audio-aided query (118). If said audio data contains a human voice, the voice recognition system (104, 109) returns one or more search results (e.g., some identifying indicia of a matching voice model, and/or other information such as a similarity score, etc.). In another embodiment, one or more audio analysis systems (104, 109) generate a semantic search query based on at least one recognized voice model, and/or some metadata, and/or contextual data associated with one or more voice models; and in another implementation, one or more audio analysis systems (104, 109) generate a semantic search query based on user feedback (125) as explained earlier.

According to one embodiment, there is a plurality of concurrently or consecutively operating external (109) and/or internal audio analysis systems (104) that include without limitations: text-dependent and text-independent audio analysis methods, audio recognition (e.g., static learning algorithms, dynamic learning algorithms, ensemble learning, evaluation, etc.); audio source separation; audio enhancement methods (e.g., audio signal pre-processing methods, feature enhancement methods, model architectures, etc.); speech recognition (e.g., linguistics, non-linguistics, paralinguistics, etc.); music analysis; sound analysis (e.g., animal vocalizations, acoustic events, emotions, etc.); short time analysis; audio activity detection; audio feature extraction; activity recognition, source location or distance detection; source motion estimation; mood, emotion, or stress recognition of a human audio source; named entity audio recognition; landmark recognition; forensic and biometric audio signatures; and similar audio analysis systems. In another embodiment, one or more external (109) and/or internal audio analysis systems (104) can be added and removed as needed, statically and/or dynamically (e.g., “on-the-fly”, on demand, etc.).

In one embodiment, the server-system (103) may be connected to a network (102), and may search multiple network-based external collections of resources (107), and identify and/or collect audio data that is similar to the audio data of the audio-aided query (118). In one embodiment, the similarity is based on the detected audio features; and in another embodiment, the similarity is based, in case of a human speech, on the content, such as a conversation content. In one example, one or more individuals are identified that have similar voice features to those detected in the audio-aided query (118). In an alternative embodiment, a group of individuals (e.g. a criminal ring) is identified based on the similar conversation content or topic, or another content feature. In another embodiment, one or more individuals are identified based on the similar metadata of the audio data. And in another embodiment, one or more individuals are identified based on the annotation data of the audio data. Any such audio data may be collected and stored in the electronic memory and/or one or more collections of resources (106, 107) that are local or remote to the server-system (103).

In another embodiment, one or more external (109) and/or internal audio analysis systems (104) can perform text-dependent analysis and/or text-independent analysis to examine information associated with one or more audio-aided queries (118), and/or audio signals that are similar to the audio data of the query (118), and/or textual information or imagines associated with such audio data. And in one implementation, all such data may reside in one or more external (107) and/or internal collections of resources (106), such as, without limitations: published on a digital medium, or a website accessible over the Internet, or a password-protected database, or a file system, etc.

The audio analysis system (104, 109), in one embodiment, comprises of an audio data recognition module that is configured to recognize certain audio features, and/or content (in case of a human speech), and/or metadata of at least some audio data that is published on a digital medium and at least some text published proximate to the audio data; and a processor that receives and analyzes audio data and text to obtain a contextual descriptor by matching at least some features, content, or metadata of the audio data with at least some said textual data. The textual descriptor may function to describe, identify, index, or name the audio data or content within the audio data. Such audio analysis system (104, 109) may be further configured to determine a confidence level for the matched audio data and textual data, etc.

In another embodiment, said audio analysis system (104, 109) accumulates text from proximity of some audio data, where in one implementation, it may detect text in proximity of audio data while searching for audio data or content that is similar to the audio-aided query (118). Said analysis system (104, 109) may be programmed, for example, to accumulate text that appears on the same document page or resource as the similar audio data, or content, or metadata, or within a predefined distance of said similar audio data, or content, or metadata that may include predefined tags. The text may be a header or the body of an article where the similar audio data, or content, or metadata appears. The audio analysis system (104, 109) may accumulate the text it encounters to determine the audio signal source (120) or its features. For example, the server-system (103) may compute a correlation between a name detected in the accumulated text and the audio data provided as part of the audio-aided query (118).

In another embodiment, an audio analysis system (104, 109) may accumulate text from a proximity of multiple identified similar audio data sets, increasing the amount of text available for analysis. And in alternative embodiment, the audio analysis system (104, 109) may perform multiple searches to identify similar audio data based on a single audio signal received as part of the query (118). Yet in another embodiment, the audio analysis system (104, 109) may aggregate accumulated text from one or more searches when the search results in duplicate audio data sets. For example, if the audio analysis system (104, 109) encounters duplicate audio data sets, said system may aggregate text that is proximate to the similar audio data to improve the identification of one or more audio signal sources (120).

According to another embodiment, one or more external (109) and/or internal audio analysis systems (104), and/or external (108) and/or internal search systems (105) can filter the accumulated text to obtain candidate names of one or more audio signal sources (120), as well as structured data associated with the audio data. Structured data, for example, may include information related to: date of birth, occupation, gender, and the like. In alternative embodiments, one or more filters may be employed to filter the accumulated text. For example, one technique includes using a large-scale dictionary of occupations as a filter. In one embodiment, a large-scale dictionary of occupations may be produced from an on-line information source, a knowledge base, or other collections of resources, and used to filter the accumulated text to extract titles (i.e., a job title). In other embodiments, other information sources such as a nationality classifier, for example, may be used to produce lists of nationalities or similar filters.

In an alternative embodiment, for example, a job title or similar information may be recognized in the accumulated text by various techniques. For instance, a job title may be recognized if the job title and the last name of a person (audio signal source) occur as a phrase in the accumulated text. In another embodiment, a job title may be recognized in the accumulated text if a partial match of a person's title occurs in the accumulated text. For example, either the first or the last name of a person in combination with a job title may be present. Additionally, or alternately, a job title may be recognized in the accumulated text if a combined name and job title occur in the accumulated text. For example, a concatenated term may be present in the accumulated text.

In alternative embodiments, other techniques may be employed to recognize, for example, job titles in the accumulated text, including linguistic analysis, cultural context, language translation, etc. For example, a plurality of name recognition algorithms may be used that recognize capitalization, look for key words and phrases, look at the content or context of the surrounding text, and the like. In various embodiments, algorithms may be used to determine the accuracy or correctness of the information. In alternate embodiments, more than one name may be correct for an audio signal source (120) (e.g., a person with several names or aliases may be detected), or the audio data may include more than one audio signal source (120), etc.

According to one embodiment, one or more external (109) and/or internal audio analysis systems (104) individually process one or more audio data sets of the audio-aided query (118) and return their results to one or more front-end servers (126) and/or to another circuitry. In some embodiments, one or more front-end servers (126) or other circuitry executes one or more analytic actions on the results of one or more audio analysis. The said analytic actions, without limitations, may include: combining at least some information produced by at least two of the plurality of audio analysis systems (104, 109) into a compound result; combining at least one of the plurality of audio analysis results and at least one of the plurality of search results into a compound result; aggregating the results into a compound document; choosing a subset of results to store and/or present; and ranking the results as configured by the ranking logic. In another embodiment, one or more audio analysis systems (104, 109) implement machine learning techniques for the audio-aided query (118) processing, such as, without limitations: predictive analytics, learning to rank, computer vision, and others.

With the benefit of annotations and other metadata, the server-system (103) can produce more complete and germane results. However, the primary use of annotations in the proposed invention is to collect relevant knowledge about the subjects and objects of interest. The audio recognition function (104, 109) discussed in this invention is supplemental to the annotation collection, providing additional audio information and enhancing the accuracy and completeness of content retrieval.

As previously described, in one or more embodiments, the server-system (103) includes a front-end server (126) or another circuitry, where the front-end server (126) or another circuitry provides an API interface (121) and receives one or more audio-aided queries (118) from one or more electronic devices (101). The front-end server (126) or other circuitry, in one implementation, upon receiving an audio-aided query (118), executes some processing logic, sending the annotations and other metadata to one or more internal (105) and/or external search systems (108) for concurrent or consecutive processing, and/or to one or more external systems (110), such as a language translation or linguistic analysis system.

In one implementation, the front-end server (126) or another circuitry, upon receiving an audio-aided query (118), as depicted in the FIG. 5, executes some processing logic, concurrently sending (in parallel) some data of the audio-aided query (118) (represented by “1” and the solid-line arrows in the FIG. 5) to one or more internal (104) and/or external audio analysis systems (109), and to one or more internal (105) and/or external search systems (108); and in another implementation, to one or more external systems (110), or in any combination of said systems and steps.

And in another implementation, after receiving at least some results from one or more of said systems (as exemplified by “1” and the dash-line arrows in the FIG. 5), processing a request in parallel, executing some analytic action, according to the analytic action configuration, whether generating additional results and/or transforming at least some said results, and/or storing at least some said results in one or more external (107) and/or internal collections of resources (106), and/or performing some other or no actions at all. And in another implementation, submitting at least some said results and any other data for further processing by one or more of the systems, or some other system; and performing as many of such iterations as necessary. The described steps, the systems employed, and the data produced or manipulated with, can be combined, amended, repeated, and used in any combination, sequence, and/or permutation.

In another implementation, the front-end server (126) or another circuitry, upon receiving an audio-aided query (118), as depicted in the FIG. 6, executes some processing logic, consecutively (or consecutively and concurrently) sending some data of the audio-aided query (118) (as represented by the sequence number and the solid-line arrows in the FIG. 6) to one or more internal (104) and/or external audio analysis systems (109), and/or to one or more internal (105) and/or external search systems (108), and/or to one or more external systems (110); and receiving at least some results from said system(s) (as represented by the sequence number and the dash-line arrows in the FIG. 6), executing some analytic action, according to the analytic action configuration, and/or generating additional results, and/or transforming at least some of the results, and/or storing at least some of the results in one or more external (107) and/or internal collections of resources (106), or performing some other or no actions at all.

And in another implementation, submitting at least some of the results and any other data for further processing by one or more of said systems, or some other system; and performing as many of such iterations as necessary. The described steps, the systems employed, and the data produced or manipulated with, can be combined, amended, repeated, and used in any combination, sequence, and/or permutation.

The proposed invention relates to the systems and methods for data collection and retrieval using an audio-aided query (118). As already mentioned, the audio analysis process discussed herein, provides, besides information collection, an additional mechanism for more accurate and complete data retrieval. The data retrieval is performed by one or more internal (105) and/or external search systems (108) operatively and/or communicatively coupled with one or more external (107) and/or internal collections of resources (106); and in some embodiments with one or more internal (104) and/or external audio analysis systems (109). In one implementation, said external (108) and/or internal search system (105) consists of a program of instructions executed by one or more processors; and in another—a circuitry; and in another—one or more computers; and yet in another—a distributed computing infrastructure; and in the other embodiment—an external search engine service.

Said search system (105, 108) can locate and provide relevant information in response to a search query from one or more front-end servers (126) or another circuitry, and/or one or more external systems (110), and/or one or more electronic devices (101), and/or one or more audio analysis systems (104, 109), as explained earlier. In one implementation, the search system (105, 108) is configured to search static data; and in another implementation, the search system (105, 108) is configured to search steaming data (e.g., computer network traffic, phone conversations, ATM transactions, streaming sensor data, etc.).

In one embodiment, one or more external (107) and/or internal collections of resources (106) may contain textual, audio, and/or visual, and/or other information that relates or includes, but not limited to the following: information about previous processing of one or more audio signals, person's biographical information, demographical information, academic information, employment-related information, address and location information, contact information, social network-related information, criminal and court records-related information, motor vehicle-related information, financial and credit-related information, risk management-related information, property records-related information, biometric information, medical information, Internet-based records, telephone records, telecom records (communications and/or metadata), government records, media records, objects/subjects associations and connections-related information, personal preferences-related information, relationships-related information, affiliations-related information, biometrics-related information, and genealogical information, etc.

According to one implementation, one or more search systems (105, 108) can execute some analytic action, as configured in the search logic, to determine what information and in what external (107) and/or internal collections of resources (106) it shall be searched, in order to locate and provide the relevant information (e.g., searching a registry database first, etc.); and what search enabling technology to employ (e.g., distributed search, parallel search (e.g., MapReduce), data stream mining, etc.); and what search algorithms to use; and what search techniques shall be applied (e.g., discovering, crawling, transformation, indexing, cataloging, keyword searches, natural language searches, data mining, deep and dark web mining, etc.). In one embodiment, said search system (105, 108) or other circuitry may determine the search parameters based on the results generated by one or more audio analysis systems (104, 109), and/or search systems (105, 108), and/or external systems (110).

In another implementation, the content of the search results can be filtered to enhance the search relevancy and/or it can be sanitized to remove private or personal information (e.g., to comply with legal or business requirements, etc.). In another implementation, the search system (105, 108) can locate and index information stored in one or more external (107) and/or internal collections of resources (106) to be able to quickly locate relevant information by accessing indexes in response to a search query, providing a near real-time response. Furthermore, the search system (105, 108) or other circuitry can amend search results based on the query (118) annotation data and other metadata, and/or contextual data.

In one embodiment, one or more audio analysis systems (104, 109) may generate the query-related audio data and/or similar audio data (or identifying indicia) as a result of audio analysis, including information based on one or more recognized audio signal sources (120). One or more search systems (105, 108) can then perform a semantic or other search, based on at least some annotation data of the recognized audio signal sources (120), or other metadata, and/or contextual or content data associated or derived from said audio data, as well as any feedback (125) associated with previous and/or current data retrieval queries (118).

In one embodiment, the server-system (103) includes a repository (one or more collections of resources (106, 107)) containing personal wiki-type profiles (123) of the encountered individuals or other targets (people, places, events, etc.). The server-system (103) assembles a wiki-type profile (123) for each encountered individual, where the profile (123) consists of information compiled by processing audio-aided queries (118), relevant information provided by users (117), and information amassed from other resources that are not part of the query (118) processing.

In one implementation, a wiki-type profile (123) can be presented as part of the report (119); and in another implementation the profiles (123) can be accessed by users via a user interface (122) (e.g., using a network-enabled computer or a mobile device, etc.). In one embodiment, each tenant (112) (customer) may have separate (private) one or more of repositories, where the separation is achieved using: programmatic resource segregation (e.g., application-level access control), and/or virtualization technologies, and/or network-level separation, and/or hardware-level separation, etc.

In one embodiment, and as exemplified in the FIG. 8, a user starts a teleconference session with one or more participants using a teleconferencing application installed on a mobile device (101) (201). The user then captures participant's voice using the application interface (115) (202). The system automatically extracts the person's voice (120) and determines its sufficiency for further processing (203). User also enters some annotation information related to the individual (participant) and/or the meeting details, or anything else that is directly or indirectly related to said individual or the meeting (115). For example, the participant's email (if known) and photograph of participant's car (if available), etc., (204). The teleconferencing application adds a timestamp, the IMEI identifier of the mobile device, and the phone number (SIM)—providing additional annotations (205). The user then submits the audio-aided query (118) to the distributed computing system (103) for processing via the application interface (115) (206).

In one embodiment, and as exemplified in the FIG. 9, a front-end server (126) that consists of an API gateway (121) that receives network requests and a distributed application server that processes the requests, receives an audio-aided query (118) (207). The application server parses the query request (118) and submits the relevant data to the audio analysis system (104, 109) that executes text-dependent and text-independent audio analysis and other analyses (208). The audio analysis system generates a voice model and searches for similar audio data and associated data. Once the information from the above analyses is collected (audio data, images, textual results, metadata, etc.) and the person (audio signal source) is probabilistically identified, the application server assigns an identifier (new or existing) to the audio signal source (120) and makes the results available to the application server (209).

In the interim, the application server also submits annotations and other metadata to multiple search systems (105, 108) (210). Where one search system looks for audio data associated with the annotations and other metadata (or an audio analysis system (104, 109), depending on the implementation) (210a). And another search system looks for text and images associated with annotations and other metadata in a plurality of data storage systems (collections of resources (106, 107)) (210b).

The application server then receives the results from all systems, processes them according to the preconfigured logic; and in one implementation, submits the processed results for additional processing to the audio analysis system (104, 109) and/or the search system (105, 108) (211). The application server again receives the results, analyzes them; and in another implementation, makes requests to external systems (110) for additional data or processing, receives the responses and conducts additional analytic processing to infer additional knowledge (212).

The application server, in one implementation, sends an SMS message if a certain condition is met to multiple mobile devices or other computing systems based on the query (118) processing results described above and the configurations (213). In addition, the application server compiles a report (119) from said results, per customer's (112) settings (214). The application server then sends a push message to the device (101), notifying the user that the report (119) is ready (215). In addition, the application server records some reported results into a repository containing wiki-type profiles (123) of each encountered person, where it adds this information to an existing profile (123) or creates a new profile if the person is encountered for the first time (216).

In one embodiment, and as exemplified in the FIG. 10, while the user is still participating in the teleconference, the application (101) receives a push message from the distributed computing system (103), notifying the user that the report (119) is ready (217). If the user opts to show the report, the application (101) retrieves the report (119) from the distributed computing system (103) and displays it to user in a presentation interface (116) (218). User views the report (119) while in the conference call (or later), where the report has multiple topics grouped in tabs, consisting of text, images, or other data (116) (219). Optionally, the user may provide additional information (if known) and/or request more information about one or more of the report's topics by sending feedback (125) to the distributed computing system (103) (220). The application (101) then transmits the feedback (125) to the distributed computing system (103) for storage and processing, and some information from the feedback may be used to trigger additional processing, modifying the information in the individual's wiki-type profile (123) and/or elsewhere (221).

The above identified modules or programs (i.e., sets of instructions) need not be implemented as separate software programs, procedures or modules, and thus various subsets of these modules may be combined or otherwise rearranged in various embodiments. Each of the operations described herein or shown in the corresponding images may correspond to instructions stored in a computer memory or non-transitory computer readable storage medium.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or system for attaining the disclosed result, as appropriate, may separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. A circuitry-implemented system for processing audio-aided data collection and retrieval:
having one or more electronic devices with one or more processors and memory storing one or more programs for execution by the one or more processors, and having one or more network interfaces:
where said memory is configured to store at least some audio data that contains at least some of the following: human audio biometric data, non-human audio characteristics data; and
where said memory is configured to store one or more user-generated or electronic device-generated annotations of at least some of the audio data; and
said one or more electronic devices are configured to transmit using one or more network interfaces, at least some data of the one or more audio-aided queries which consist of at least some audio data and at least some annotation data; and
having one or more server-systems with one or more processors and memory storing one or more programs for execution by the one or more processors, and having one or more network interfaces, and one or more audio analysis systems, and one or more search systems, and one or more collections of resources:
where one or more network interfaces are configured to receive at least some audio-aided query data; and
said one or more audio analysis systems are configured to process at least some audio data by:
subjecting at least some audio data to analysis for determining at least some property related to at least some human audio biometrics, or non-human audio characteristics, or absence thereof in said audio data, using text-dependent or text-independent analysis techniques; and
said one or more search systems are configured to process at least some audio-aided query data by:
performing one or more searches in one or more collections of resources using at least some annotation data; and
performing one or more searches in one or more collections of resources, using at least some data produced as a result of the audio analysis; and
said one or more collections of resources are configured to store at least some data related to, or being a result of at least some previous audio-aided query transaction; and
said one or more server-systems are configured to transmit via one or more network interfaces, at least some data obtained as a result of processing the one or more audio-aided queries, where said data includes at least some data in connection with one or more persons, or subjects or objects associated with one or more persons.

2. The system of claim 1, where at least one of: said one or more collections of resources, said one or more audio analysis systems, said one or more search systems are external.

3. The system of claim 1, where said audio analysis system and said search system are operatively coupled logical subsystems of a single system.

4. The system of claim 1, where said one or more server-systems are configured to transmit via one or more network interfaces, one or more notification messages as a result of processing one or more audio-aided queries.

5. The system of claim 1, where the memory of one or more electronic devices is configured to store at least some data derived as a result of processing at least some audio data, or at least some data derived as a result of processing at least some annotation data.

6. The system of claim 1, where one or more electronic devices or server-systems have a user interface, where one or more users can configure at least some settings or access at least some information related to an audio-aided query.

7. The system of claim 1, where said one or more electronic devices are configured to receive one or more packets of data in one or more transmission sessions, and said one or more server-systems are configured to send one or more packets of data in one or more transmission sessions related to a single (one) audio-aided query.

8. The system of claim 1, where said one or more electronic devices are configured to receive from one or more server-systems at least some data obtained as a result of processing said one or more audio-aided queries, and said one or more electronic devices are configured to transmit to the server system at least some data after receiving the data obtained as a result of processing said one or more audio-aided queries from the server-system.

9. The system of claim 1, where said electronic device or said server-system are communicatively or operatively coupled with a plurality of other circuitry-implemented systems.

10. A circuitry-implemented method for processing audio-aided data collection and retrieval, where:
one or more electronic devices:
acquire at least some audio data, where said audio data contains at least some of the following: human audio biometric data, non-human audio characteristics data; and
obtain one or more user-generated or electronic device-generated annotations of at least some of the audio data; and
transmit over a network at least some data related to one or more audio-aided queries which consist of at least some audio data and at least some annotation data; and
one or more server-systems:
receive at least some data of one or more audio-aided queries and perform at least some analysis to determin at least some property related to at least some human audio biometrics, or non-human audio characteristics, or absence thereof, using text-dependent or text-independent analysis techniques; and
performs one or more searches in one or more collections of resources, using at least some data produced as a result of at least some audio-aided query data analyses; and
performs one or more analytic actions on at least some data produced as a result of said searches or said audio-aided query data analyses; and
transmits over a network at least some data obtained as a result of processing one or more audio-aided queries, where the data includes at least some data in connection with one or more persons, or subjects or objects associated with one or more persons.

11. The method of claim 10, where said server-system stores at least some data from said analyses or searches into one or more internal or external collections of resources, having one or more profiles.

12. The method of claim 10, where said audio-aided query data analysis involves searching one or more collections of resources using at least some annotation data or metadata.

13. The method of claim 10, where said server-system receives at least some data of one or more audio-aided queries and performs one or more searches in one or more collections of resources before determining at least some property related to at least some human audio biometrics or non-human audio characteristics.

14. The method of claim 10, where said server-system performs one or more searches in one or more collections of resources, using at least some data produced as a result of at least one of the audio-aided query data analyses, resulting in locating at least some data related to, or being a result of at least some previous audio-aided query transaction.

15. The method of claim 10, where said one or more searches in one or more collections of resources result in locating at least some data that includes at least one of: information from/about previous searches, biographical information, demographical information, academic information, employment-related information, address and location information, contact information, social network-related information, criminal and court records-related information, motor vehicle-related information, financial and credit-related information, risk management-related information, property records-related information, biometric information, medical information, the Internet-mining records, government records, media records, telecommunications-related records, forensic records, associations and connections-related information, preferences-related information, relationships-related information, and genealogical-related information.

16. The method of claim 10, where the processing of said one or more audio-aided queries involves combining at least some data produced as a result of the audio-aided query data analyses and at least some data produced as a result of the searches into a compound result.

17. The method of claim 10, where at least one of said analytic actions involves determining at least some relevance of at least some data produced as a result of the audio-aided query data analyses or searches.

18. The method of claim 10, where said server-system receives at least some feedback data after transmitting over a network at least some data obtained as a result of processing one or more audio-aided queries, where said feedback data includes at least some data in connection with one or more audio-aided query transactions or one or more persons, or subjects or objects associated with one or more persons.

19. The method of claim 10, where the steps of said method are integrated with a plurality of other circuitry-implemented methods.

20. A method for collecting and presenting information associated with one or more persons, or subjects or objects associated with one or more persons, comprising of:
obtaining at least some audio information and at least some user-generated or electronic device-generated annotation data of at least some of the audio information; and
identifying one or more human voices or one or more sounds of non-human nature in said audio information and performing at least some feature extraction; and
saving at least some part or some product of said audio information and at least some part or some product of the annotation data in one or more collections of resources; and
comparing at least some audio information or some product of said audio information with at least some audio information or some product of audio information or other data stored in one or more collections of resources; and
performing one or more searches in one or more collections of resources, using at least some data produced as a result of comparing at least some audio information or some product of audio information; and
performing one or more analytic actions on at least some data produced as a result of said searches or said comparisons; and
transmitting over a network at least some data that includes at least one of: information from/about previous searches, biographical information, demographical information, academic information, employment-related information, address and location information, contact information, social network-related information, criminal and court records-related information, motor vehicle-related information, financial and credit-related information, risk management-related information, property records-related information, biometric information, medical information, the Internet-mining records, government records, media records, telecommunications-related records, forensic records, associations and connections-related information, preferences-related information, relationships-related information, and genealogical-related information.

21. The method of claim 20, where after transmitting over a network at least some data, the method includes receiving over a network at least some feedback data, where said feedback data includes at least some data in connection with one or more audio-aided query transactions or one or more persons, or subjects or objects associated with one or more persons.

22. The method of claim 20, where said method includes a step of searching one or more collections of resources using at least some annotation data or metadata.

23. The method of claim 20, where obtaining at least some audio information involves at least one of: unobtrusively examining audio information until a predetermined criterion is reached; and displaying visual prompts to a person and receiving at least some speech utterances from the said person.

24. A method for processing audio-aided data collection and retrieval, comprising of:
receiving at least some audio signal that contains human audio biometric data or non-human audio characteristics data; and
identifying one or more persons, or subjects or obj ects, being at least some audio signal source; and
quarrying at least some data that includes at least one of: information from/about previous searches, biographical information, demographical information, academic information, employment-related information, address and location information, contact information, social network-related information, criminal and court records-related information, motor vehicle-related information, financial and credit-related information, risk management-related information, property records-related information, biometric information, medical information, the Internet-mining records, government records, media records, telecommunications-related records, forensic records, associations and connections-related information, preferences-related information, relationships-related information, and genealogical-related information; and
transmitting over a network or presenting on a display at least some data obtained as a result of processing at least some audio signal, where the data includes at least some data in connection with one or more persons, or subjects or objects associated with one or more persons.
